(19) United States
(12) Patent Application Publication
(10) Pub. No.: US 2012/0013113 A1
(43) Pub. Date: Jan. 19, 2012

(54) AERODYNAMIC PERFORMANCE IN PASSENGER VEHICLES

(75) Inventors: Rodney Jason Trenne, Midvale, UT (US); Richard Hoyle, Clarkston, MI (US); Kevin Robert Czinger, Brentwood, CA (US); Broc William TenHouten, Los Angeles, CA (US); Philippe Hart Gow, Santa Monica, CA (US)

(73) Assignee: Coda Automotive, Inc., Santa Monica, CA (US)

(21) Appl. No.: 13/042,577

(22) Filed: Mar. 8, 2011

Related U.S. Application Data
(60) Provisional application No. 61/365,213, filed on Jul. 16, 2010.

(51) Int. Cl. B62D 25/18

(52) U.S. Cl. 280/849

(57) ABSTRACT

Systems and methods providing improved aerodynamic performance in passenger vehicles are generally described. The underbody of the passenger vehicle can be, in some cases, relatively smooth to reduce aerodynamic drag on the vehicle. In addition, the contour of the underbody can include one or more recessed portions that maintain relatively constant air pressure as air passes under the vehicle. The wheel fairings of the vehicle can also include one or more features that reduce aerodynamic drag. For example, the vehicle can include wheel fairings comprising one or more contours adjacent the interface between the wheel well and the underbody that serve to reduce pressure buildup adjacent the wheel well. In some embodiments, one or more wheels can include a wheel well cover that at least partially encloses the outside of the wheel well, such that air can pass smoothly along the side of the vehicle. In some embodiments, such as when the wheel well cover at least partially encloses a movable wheel, the wheel well cover can be adjustable such that contact between the tire (or any other part of the wheel) and the wheel well cover is avoided. The wheel well cover can include one or more curves (e.g., along 1-dimension as in a cylinder or along 2-dimensions as in a sphere), in some instances, which can accommodate a turning wheel such that the need to displace the wheel well cover in response to a turning wheel is reduced.

### RELATED APPLICATIONS

This application claims priority under 35 U.S.C. §119(e) to U.S. Provisional Patent Application No. 61/365,213, filed Jul. 16, 2010, and entitled “Aerodynamic Performance in Passenger Vehicles,” which is incorporated herein by reference in its entirety for all purposes.

### FIELD

Systems and methods providing improved aerodynamic performance in passenger vehicles are generally described.

### BACKGROUND

Aerodynamic drag can dramatically affect the energy efficiency of a passenger vehicle. While vehicle manufacturers have focused much of their efforts on reducing aerodynamic drag on the vehicle body, the underbody and wheel wells have received relatively little attention.

### SUMMARY

Systems and methods to produce improved aerodynamic performance in passenger vehicles are provided.

In one aspect, a passenger vehicle is provided. The passenger vehicle can comprise, in some embodiments, a wheel well and a moveable wheel well cover, wherein, at a given turning angle, the wheel well cover is constructed and arranged to assume a position dependent upon at least one of the speed of the vehicle, the turning rate, and the suspension compression.

In some instances, the passenger vehicle can comprise a longitudinal axis extending from a front end to a rear end of the vehicle, a transverse axis extending from a first side to a second side of the vehicle, a wheel well, and an underbody surface comprising a recessed portion adjacent the wheel well, wherein a line joining the wheel well and the recessed portion is substantially parallel to the transverse axis of the vehicle. In some embodiments, the recessed portion is constructed and arranged to mitigate or inhibit the development of high pressure zones underneath the vehicle while the vehicle is moving.

Other advantages and novel features will become apparent from the following detailed description of various non-limiting embodiments when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the embodiment. In the figures:

FIGS. 1A-1F include schematic diagrams of the underbody of a passenger vehicle, according to one set of embodiments;

FIG. 2 includes a schematic diagram of the side of a passenger vehicle, according to one set of embodiments;

FIG. 3 includes, according to one set of embodiments, a schematic illustration of a rotary wheel well cover actuation mechanism;

FIGS. 4A-4C include exemplary schematic illustrations of a passenger vehicle;

FIG. 5 includes an exemplary schematic illustration of a linear wheel well cover actuation mechanism;

FIGS. 6A-6D include schematic diagrams outlining the position of a wheel well cover under various conditions, according to one set of embodiments;

FIG. 7 includes a plot of the extension factor as a function of wheel turning rate, according to some embodiments;

FIG. 8 includes an exemplary plot of the extension factor as a function of suspension compression; and

FIGS. 9A-9B include schematic diagrams of a passenger vehicle, according to one set of embodiments.

### DETAILED DESCRIPTION

Systems and methods providing improved aerodynamic performance in passenger vehicles are generally described. The underbody of the passenger vehicle can be, in some cases, relatively smooth to reduce aerodynamic drag on the vehicle. In addition, the contour of the underbody can include one or more recessed portions that maintain relatively constant air pressure as air passes under the vehicle. The wheel fairings of the vehicle can also include one or more features that reduce aerodynamic drag. For example, the vehicle can include wheel fairings comprising one or more contours adjacent the interface between the wheel well and the underbody that serve to reduce pressure buildup adjacent the wheel well. In some embodiments, one or more wheels can include a wheel well cover that at least partially encloses the outside of the wheel well, such that air can pass smoothly along the side of the vehicle. In some embodiments, such as when the wheel well cover at least partially encloses a movable wheel, the wheel well cover can be adjustable such that contact between the tire (or any other part of the wheel) and the wheel well cover is avoided. The wheel well cover can include one or more curves (e.g., along 1-dimension as in a cylinder or along 2-dimensions as in a sphere), in some instances, which can accommodate a turning wheel such that the need to displace the wheel well cover in response to a turning wheel is reduced.

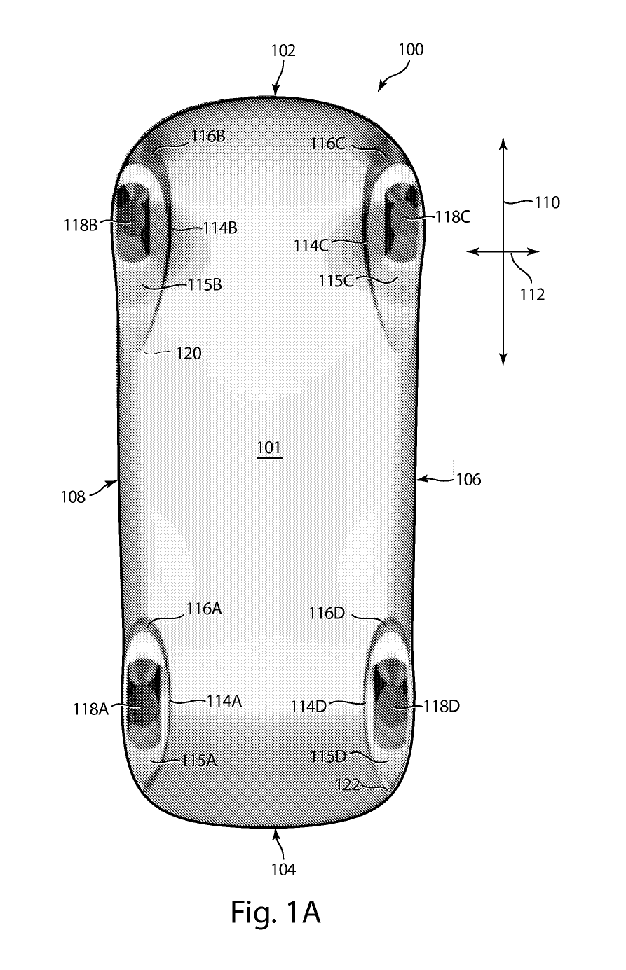

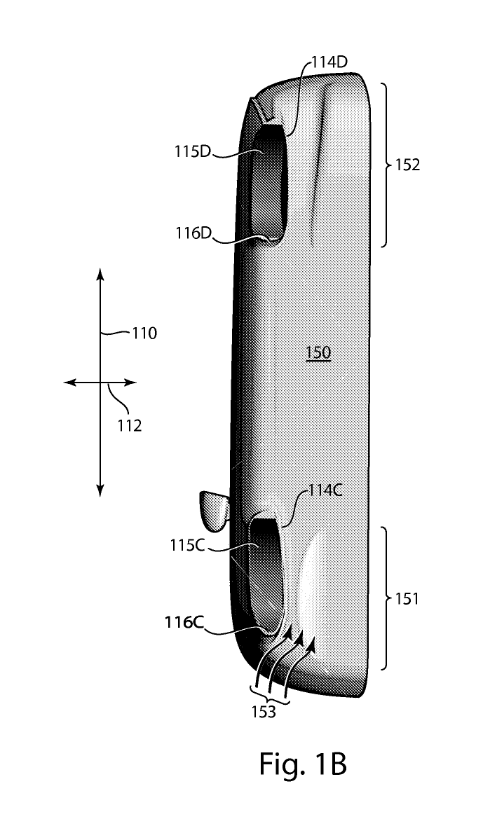

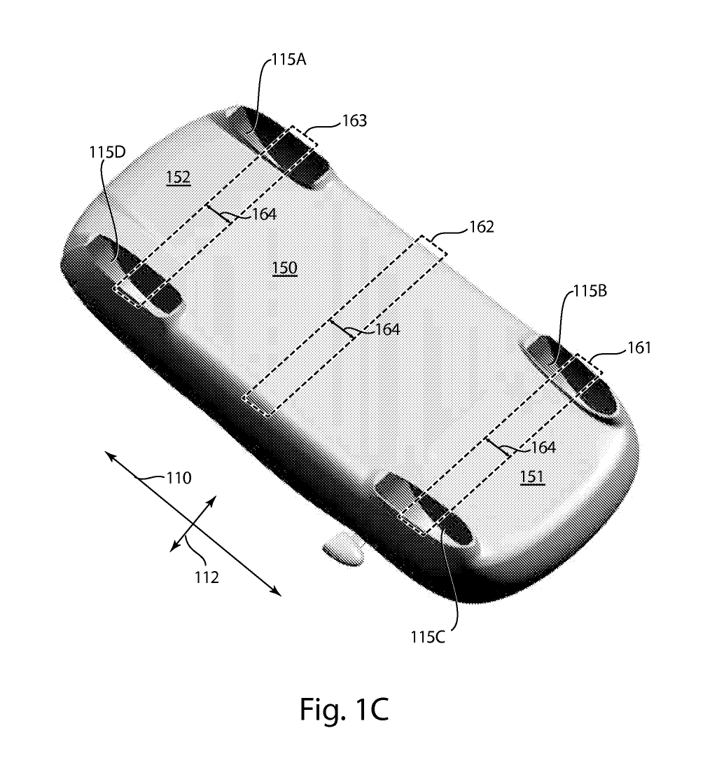

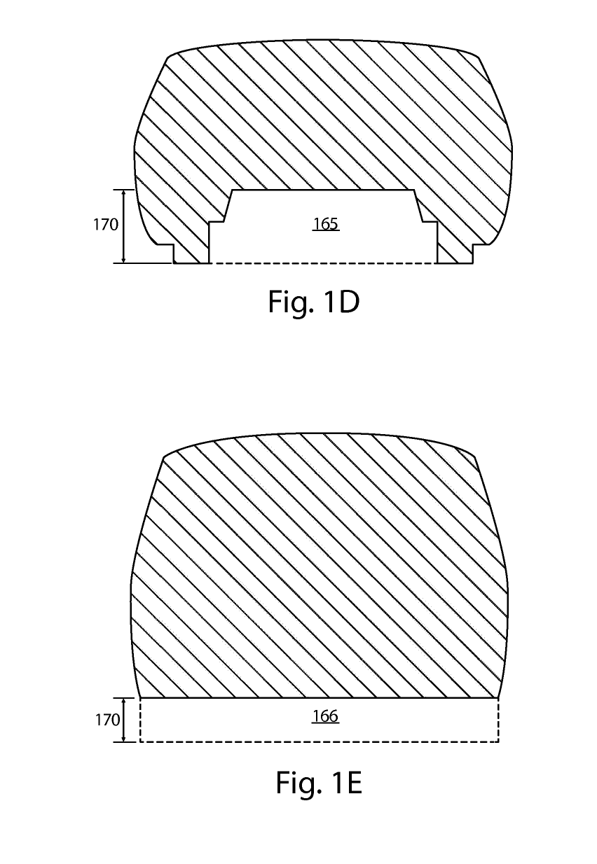

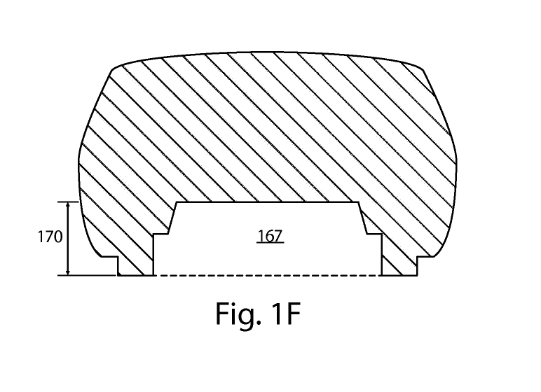

FIG. 1A includes an exemplary schematic diagram of the underbody 101 of passenger vehicle 100. Vehicle 100 includes front end 102, rear end 104, left side 106, and right side 108. In addition, vehicle 100 includes longitudinal axis 110 and transverse axis 112.

The underbody of the vehicle includes several features constructed and arranged to reduce aerodynamic drag. For example, in some cases, the vehicle can include drag-reducing aerodynamic wheel fairings 114A-D positioned below the body of the vehicle. Wheel fairings 114A-D can include curved front portions 116A-D. The curved front portions can be constructed and arranged to redirect air around tires 118A-D, such that a relatively large portion of the tire is not exposed to moving air. In some embodiments, the front portions of the wheel fairings can be substantially parabolic in shape. In addition, wheel fairings can include curvature within their rear portions. In some embodiments, the rear portions of the wheel fairings can be enclosed. The rear portion of the wheel fairings can include curved portions, in place of or in addition to the curved front portions of the wheel fairings. For example, in the set of embodiments illustrated in FIG. 1A, the rear portion of wheel fairing 114B includes curved boundary 120 that can be constructed and arranged to direct air around the wheel fairing (and therefore, direct air around the wheel well and the wheel). In the embodiments shown, front curved portion has a larger radius of curvature than the rear curved portion. In some cases, the rear portion of the wheel fairing can form a smooth curve. In other cases, the rear portion of the wheel fairing can be shaped such that the curvature forms an angle at the rearmost point of the wheel fairing. For example, in FIG. 1A, wheel fairing 114D includes a rear curvature that terminates at point 122.

The wheel fairing curvatures can be shaped, in some instances, to mitigate pressure concentrations under the vehicle, reducing drag and lift-induced drag. By shaping the wheel fairings as described above, the separation of air from the wheel fairings can be reduced, which can promote reduced turbulence and/or laminar flow around the wheels and wheel wells, and thus reduce drag. For example, as air flows around front portion 116D of wheel fairing 114D, it can be split into two air flow paths. By including a curved surface at front portion 116D, the air flow can be smoothly parted, much like in the case of an airfoil, without creating turbulence, thereby reducing drag. In addition, termination point 122 of the trailing edge of wheel fairing 114D can promote recombination of the split air streams without the creation of or at least a reduction in turbulence.

In the embodiments shown, the wheel fairing extends a distance of about 2 times the wheel opening behind the wheel. The radius of curvature on the outside of the wheel fairing can be greater than the radius of curvature on the inside of the wheel fairing so as to create an asymmetric airfoil.

In some embodiments, the underbody can include one or more recessed portions (i.e., portions including concave curvature, when viewed from underneath the vehicle). In some cases, the recessed portions promote substantially constant pressure airflow and can inhibit or prevent the formation of eddies, vortices, and/or other flow discontinuities in order to reduce lift and lift-induced drag. The recessed portions help inhibit the development of high pressure zones underneath the vehicle while the vehicle is moving.

FIG. 1B includes a schematic illustration of a vehicle underbody 150 including recessed portions 151 and 152. The recessed portions can be located proximate the wheels and/or wheel wells. For example, in FIGS. 1B-1C, recessed portions 151 and 152 are positioned adjacent wheel wells 115C and 115D, respectively. Recessed portions 151 and 152 can be constructed and arranged to accommodate air that approaches and is redirected by the adjacent wheel, wheel well, and/or wheel fairing such that high pressure zones are mitigated or do not develop. For example, in the set of embodiments illustrated in FIG. 1B, as air approaches front portion 116C of wheel fairing 114C, it can be redirected toward recessed portion 151 (e.g., along arrows 153). In the absence of recessed portion 151, the excess air redirected toward the inboard portion of the underbody would be compressed, generating a high pressure region that would increase the drag on the vehicle. The incorporation of recessed portion 151, however, provides a relatively large volume through which the redirected air can flow, reducing air compression and subsequent development of high pressure zone underneath the vehicle.

The underbody can include a shape, in some embodiments, such that the cross-sectional area underneath the vehicle through which the air flows remains relatively constant along the longitudinal axis of the vehicle. The cross-sectional area underneath the vehicle through which air flows is measured perpendicularly to the longitudinal axis of the vehicle and the ground. In addition, the cross-sectional area is defined by the area between the lower surface of the vehicle; the boundary at the lateral sides of the vehicle 106 and 108 or the inboard surface of the wheels, where present; and the ground. FIGS. 1D-1F include schematic cross-sectional illustrations of the vehicle in FIG. 1C, as taken through the front edges of control volumes 161, 162, and 163, respectively. The cross-sections illustrated in FIGS. 1D-1E are perpendicular to the longitudinal axis 110 of the vehicle and parallel to the transverse axis 112 of the vehicle. The cross-sectional area underneath the vehicle in FIG. 1D is illustrated as area 165. In FIG. 1E, the cross-sectional area underneath the vehicle is illustrated as area 166. The cross-sectional area underneath the vehicle in FIG. 1F is illustrated as area 167. In the set of embodiments illustrated in FIGS. 1D-1F, areas 165, 166, and 167 are similar. In some embodiments, no two cross-sectional areas underneath the vehicle through which the air flows (defined as outlined above) vary in area by more than about 20%, more than about 10%, more than about 5%, more than about 2%, or more than about 1%. The variability of two cross-sectional areas underneath the vehicle (Vₐᵣₑₐ) is calculated as:

$${V}_{area} = \frac{{A}_{2} - {A}_{1}}{{A}_{1}} \cdot 100 \%$$

wherein A₁ is the smaller of the two cross-sectional areas and A₂ is the larger of the two cross sectional areas.

The low-pressure design of the vehicle underbody can also be described by way of a control volume. That is, in some embodiments, a volume of space below the vehicle at a given sectional width and along a certain length can be similar to the volume of space below the vehicle at any other sectional width having the same length. As used herein, a “control volume” refers to an imaginary volume defined by the cross-sectional area underneath the vehicle (as defined above) along a portion of the longitudinal axis of the vehicle. A control volume has a length along the longitudinal axis, a width spanning the vehicle that is perpendicular to the longitudinal axis of the vehicle, and a depth that is perpendicular to the ground. For example, FIG. 1C includes control volumes 161, 162, and 163. Each of control volumes 161, 162, and 163 are perpendicular to longitudinal axis 110 of the vehicle and span the width of the vehicle. In addition, control volumes 161, 162, and 163 include depths (e.g., depths 170 illustrated in FIGS. 1D-1F) that are perpendicular to the ground. For example, Each of control volumes 161, 162, and 163 also have substantially equal lengths 164. In some embodiments, no two control volumes that have substantially equal lengths vary in volume by more than about 20%, more than about 10%, or more than about 5%. The variability of two control volumes underneath the vehicle (Vᵥₒₗ) is calculated as:

$${V}_{vol} = \frac{{V}_{2} - {V}_{1}}{{V}_{1}} \cdot 100 \%$$

wherein V₁ is the smaller of the two control volumes and V₂ is the larger of the two control volumes.

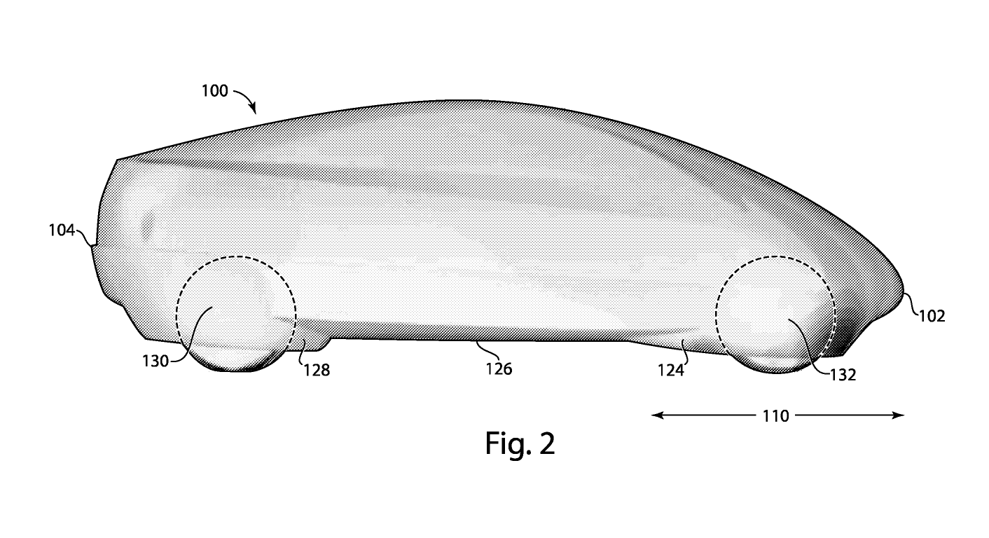

Front and/or rear portions of a wheel fairing can be arranged such that they protrude from the underbody surface of the vehicle toward the ground. FIG. 2 includes a schematic illustration of a side view of vehicle 100. In this set of embodiments, wheel fairing 114C includes rear portion 124 protruding downward from underbody surface 126. In addition, wheel fairing 114D includes front portion 128 protruding downward from underbody surface 126. In some embodiments, the front portion of a wheel fairing can be shaped such that it redirects incident air downward toward the ground. For example, as illustrated in FIG. 2, front portion 128 can be angled (sloping backward from the underbody surface 126 toward rear end 104) such that at least a portion of the air from the front of the vehicle that contacts portion 128 is redirected downward.

One or more wheel wells in the vehicle can be constructed and arranged such that it is substantially completely enclosed along at least one plane parallel to the longitudinal and transverse axes. In some cases, a wheel well can be substantially completely enclosed by positioning a wheel well cover over the outside edge of the wheel well. For example, in FIG. 2, wheel wells 115C and 115D are enclosed by wheel well covers 130 and 132, respectively. Enclosure of one or more wheels can reduce the amount of turbulence created by the sides of the wheel well, the wheel itself, and/or the tire. In some cases, the wheel well covers can promote laminar, substantially constant pressure airflow in order to reduce lift and lift-induced drag. For example, the wheel well covers can be constructed and arranged to provide a substantially continuous surface across the side of the automobile (e.g., when the wheels are not turned).

Wheel well covers can be arranged to cover movable and/or non-movable wheels. For example, in some embodiments, the rear wheels can be fixed, and the corresponding wheel well covers can be fixed in place. In some cases, the front wheels of the passenger vehicle may be movable (e.g., to steer the vehicle), in which case the wheel well cover can be constructed and arranged to move to avoid contact between the wheel and/or tire and the wheel well cover. While two-wheel steering is primarily described, it should be understood that the systems and methods described herein are equally applicable to vehicles in which more than two wheels are movable (e.g., vehicles with four-wheel steering).

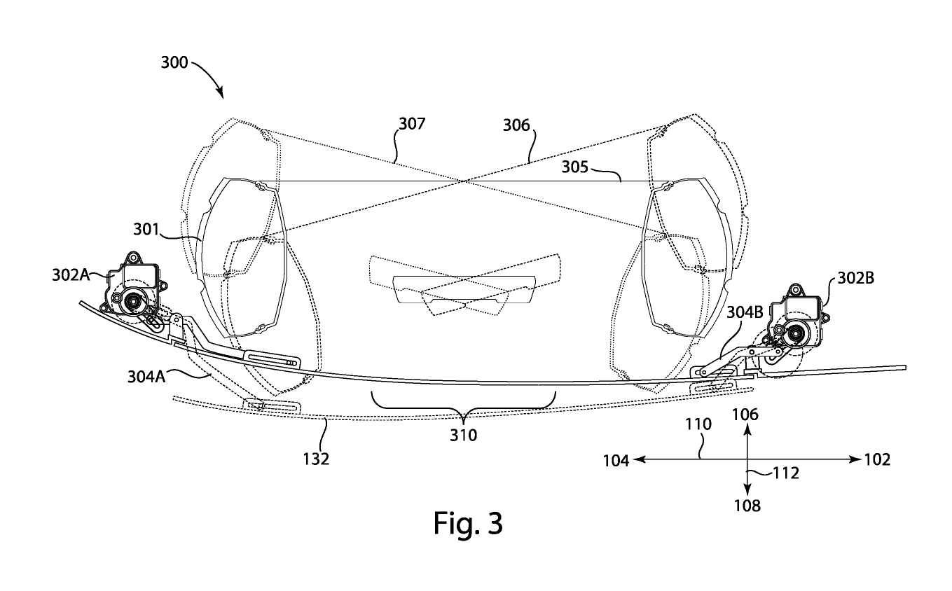

Movable wheel well covers can be actuated using any suitable mechanism. FIG. 3 includes a schematic illustration of a wheel well cover movement mechanism 300 that employs rotary actuators. FIG. 3 includes three illustrations of the system superimposed on each other, each illustration outlining the position of the wheel well cover relative to tire 301 for a specific tire position. In this set of embodiments, rotary actuators 302A-B are connected to wheel well cover 132, optionally via connection rods 304A-B. Connection rods 304A-B can be mounted to the wheel well cover via a rotary connection, which allows for the angle between the rod and the cover to change as the rod is pushed away from the wheel well. For example, as illustrated in FIG. 3, when the wheel well cover is flush against the side of the vehicle, the longitudinal axis of connection rod 304A is substantially aligned with the inner surface of the wheel well cover. When the wheel well cover is moved away from the side of the vehicle, however, the longitudinal axis of connection rod 304A is at an angle relative to the inner surface of the wheel well cover.

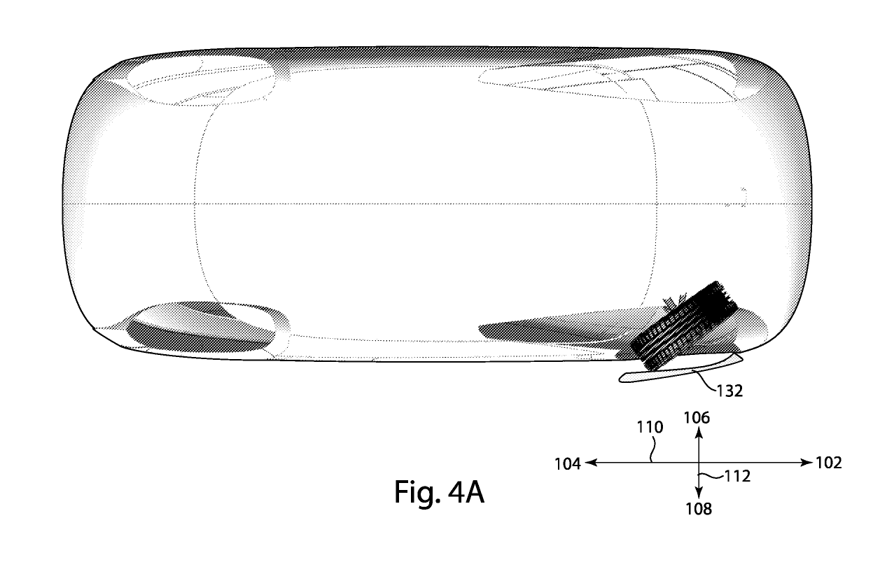

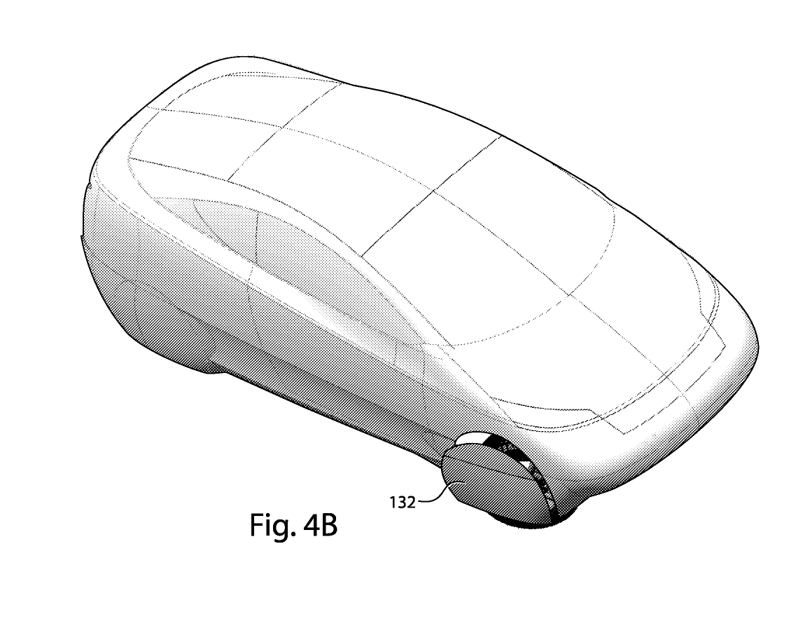

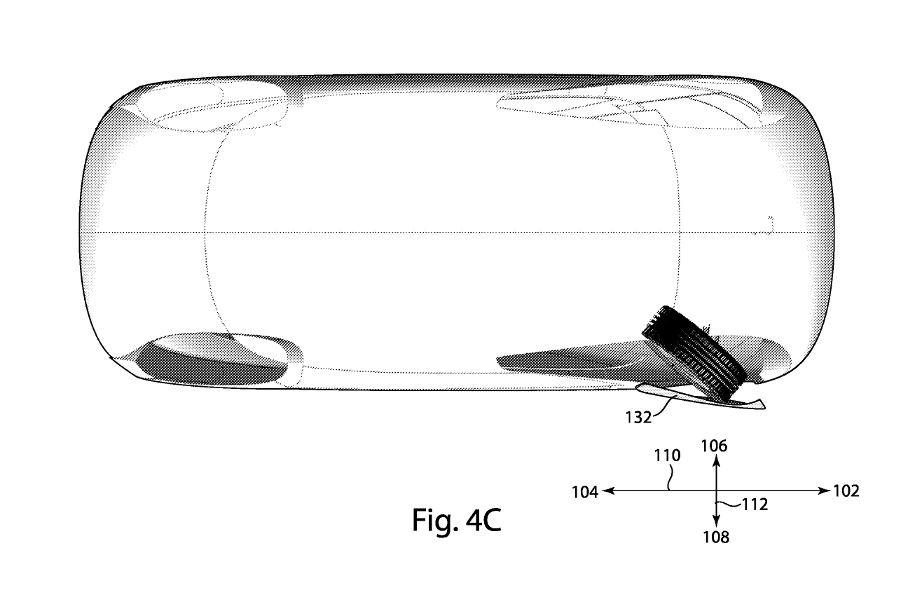

When the wheel is in a non-turning position (i.e., when the wheel is aligned along line 305), actuators 302A-B can be positioned such that the wheel well cover is close to or flush with the side of the vehicle. When the wheel is turned to the left (i.e., when the wheel is aligned along line 306), rotary actuator 302A can rotate clockwise such that the rear portion of the wheel well cover is moved outward along the transverse axis along direction 108 while the front portion of the wheel well cover remains relatively close to or flush with the side of the vehicle. FIG. 4A includes an exemplary schematic diagram illustrating the position of the wheel well cover 132 when the wheel is turned to the left, in some embodiments. FIG. 4B includes an exemplary schematic diagram of a perspective view of the vehicle illustrating the position of the wheel well cover 132 when the wheel is turned to the left, in some embodiments.

Referring again to FIG. 3, in some embodiments in which the wheel is turned to the right (e.g., when the wheel is aligned along line 307), rotary actuator 302B can rotate counter-clockwise such that the front portion of the wheel well cover is moved outward along the transverse axis in direction 106 while the rear portion of the wheel well cover remains close to or flush with the side of the vehicle. FIG. 4C includes an exemplary schematic diagram outlining the position of the wheel well cover 132 when the wheel is turned to the right, in some embodiments.

The use of a rotary actuation mechanism can allow for the use of a relatively small wheel well cover (relative to, for example, many linear actuation mechanisms) as the rotary actuators do not require much space between the edge of the wheel well cover and the front and rear surfaces of the tire. The rotary actuation mechanism can be accomplished via electronic actuation, or any other suitable type of actuation arrangement.

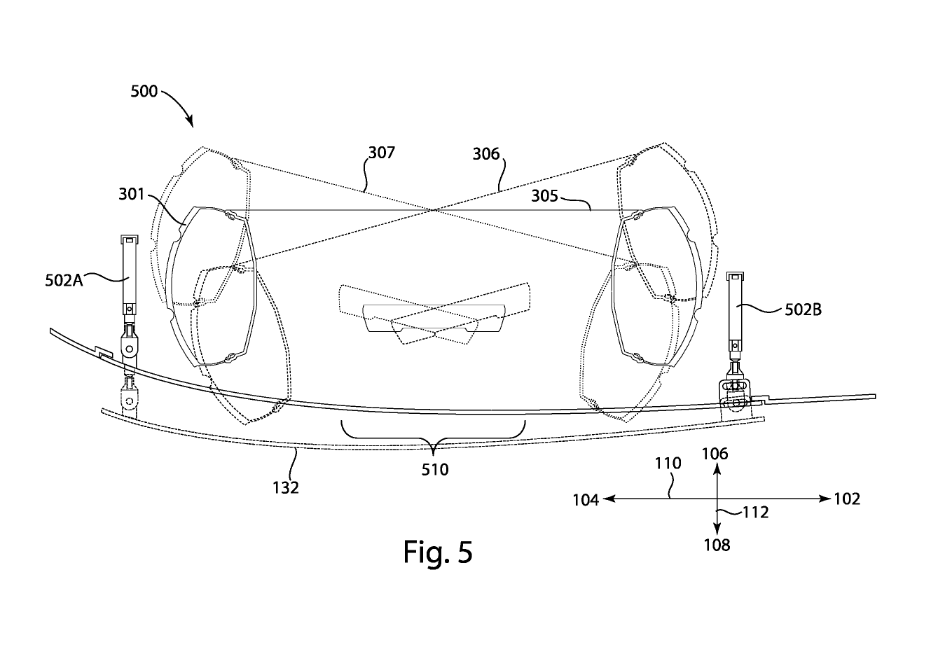

FIG. 5 includes a schematic illustration of a wheel well cover movement mechanism 500 that employs linear actuators. As in FIG. 3, FIG. 5 includes three illustrations of the system superimposed on each other, each illustration outlining the position of the wheel well cover in relation to tire 301 for a specific tire position. In this set of embodiments, linear actuators 502A-B are connected to wheel well cover 132. Any suitable type of linear actuator can be used. In some embodiments, the linear actuator can include two concentric cylindrical members. Upon actuation, the interior cylindrical member can be moved such that it protrudes outwardly from the exterior cylindrical member.

When the wheel is in a non-turning position (i.e., when the wheel is aligned along line 305), actuators 502A-B can be positioned such that the wheel well cover is close to or flush with the side of the vehicle. When the wheel is turned to the left (i.e., when the wheel is aligned along line 306), linear actuator 502A can extend outward such that the rear portion of the wheel well cover is moved outward along the transverse axis in direction 108 while the front portion of the wheel well cover remains close to or flush with the side of the vehicle. When the wheel is turned to the right (i.e., when the wheel is aligned along line 307), linear actuator 502B can extend outward such that the front portion of the wheel well cover is moved outward along the transverse axis in direction 108 while the rear portion of the wheel well cover remains close to or flush with the side of the vehicle. The use of a linear actuation mechanism can involve the use of a relatively large wheel well cover, in some cases, to provide space between the edges of the wheel well cover and the front and rear surfaces of the tire through which the actuators can move. The linear actuation mechanism can be accomplished via electronic actuation; vacuum, air, or pressure cylinder actuation; or any other suitable type.

In some embodiments, a hybrid linear and rotary actuation mechanism can be used. For example, connection rods 304A-B can be replaced with linear actuators, in some embodiments.

While wheel well covers having two actuators are described, it should be understood that, in other embodiments, additional actuators are used to control the position of a wheel well cover. For example, in one set of embodiments, a third actuator is connected to the center of a wheel well cover (e.g., connected to wheel well cover portion 310 in FIG. 3 and/or wheel well cover portion 510 in FIG. 5).

In the embodiments described above, the front portions of the wheel well covers have been shown to move smaller distances, relative to the rear portions of the wheel well cover, upon full extension of the actuators. It should be understood, however, that in some embodiments, the front and rear portions of the wheel well cover may move substantially equal distances upon full extension of the actuators. In other cases, the rear portion of the wheel well cover can move smaller distances, relative to the front portion of the wheel well cover, upon full extension of the actuators.

In addition, in the embodiments outlined above, the front and rear portions of the wheel well cover have been illustrated as being able to move independently, allowing for the angle of the wheel well cover to be varied. It should be understood, however, that in other embodiments, the wheel well covers and actuation mechanism can be constructed and arranged such that the front and rear portions of the wheel well cover are extended and retracted in concert, maintaining the orientation of the wheel well cover relative to the body of the vehicle.

The position of the wheel well cover can be controlled, in some embodiments, without detecting the wheel position. For example, the wheel well cover can be positioned based at least in part on feedback from a steering position sensor (e.g., attached to the steering column or other part of the steering system). The steering position sensor can be the same sensor that is used by the electric power steering or hydro electric power steering (if equipped). As the wheel is turned, the steering position sensor can transmit a signal to the wheel well cover actuators, which can subsequently move the wheel well cover such that contact with the wheel is avoided. The steering position signal can be transmitted via a dedicated wire connecting the steering position sensor or via a controller area network (CAN). Such systems can be advantageous as they eliminate the need for complex sliding bearings.

The position of the wheel well cover can be controlled, in some embodiments, such that the wheel and the wheel well cover are actuated in concert. For example, the steering system can include a mechanical linkage between the steering movement and the wheel well cover. In some such systems, the force to turn the steering wheel can be transmitted to the wheel well cover by a mechanical linkage or joint connected to the steering system.

In some cases, the position of the wheel well cover can depend on factors independent of the position of the wheel. For example, the position of the wheel well cover can be controlled based upon the speed of the vehicle, the rate at which the wheels are turned, and/or the suspension compression, in some embodiments. As used herein, the term “suspension compression” refers to whether the suspension system of the vehicle is compressed (i.e., the separation between the vehicle and the ground is smaller than in the vehicle's immobile state), extended (i.e., the separation between the vehicle and the ground is larger than in the vehicle's immobile state), or neutral (i.e., the separation between the vehicle and the ground is substantially similar to the separation in the vehicle's immobile state).

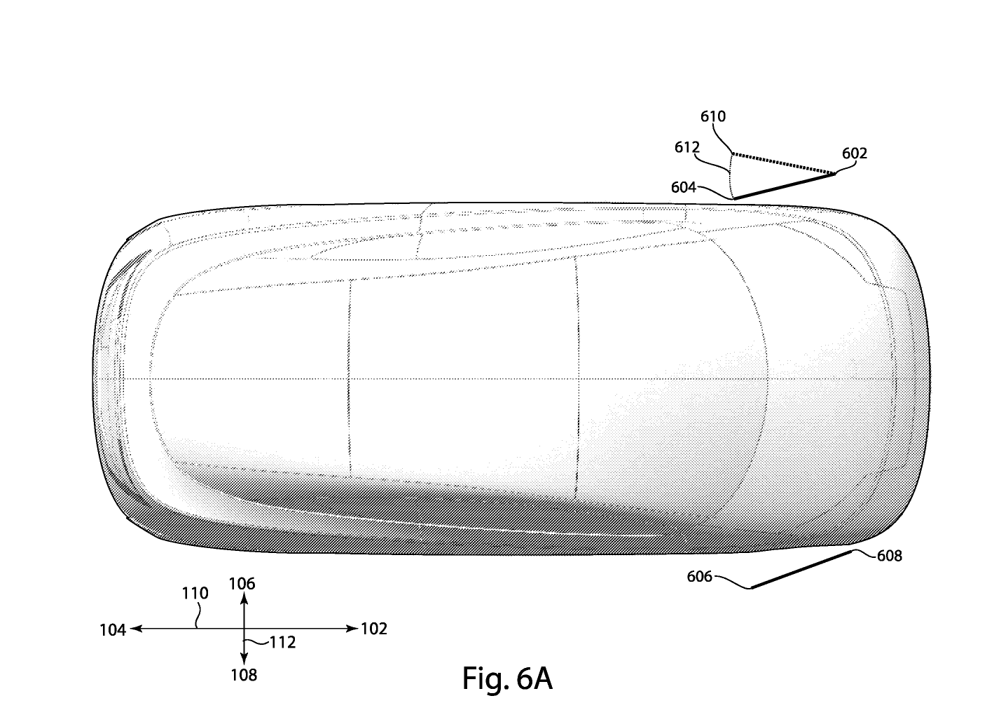

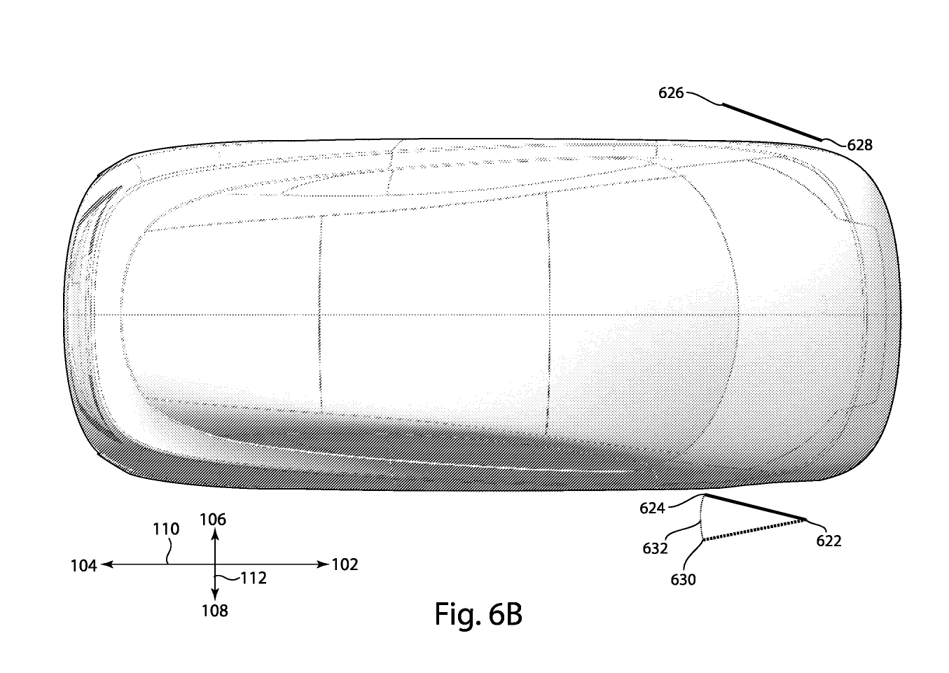

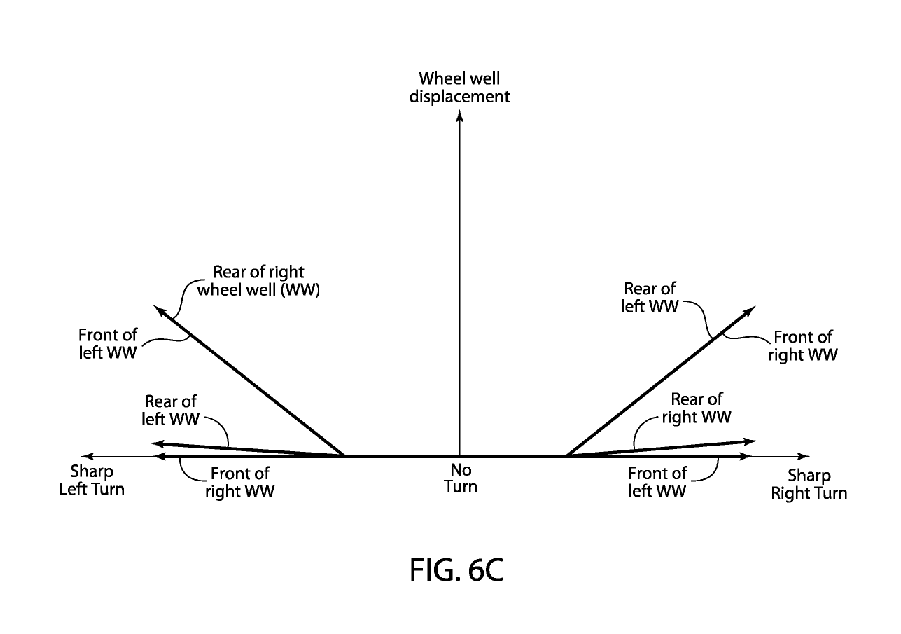

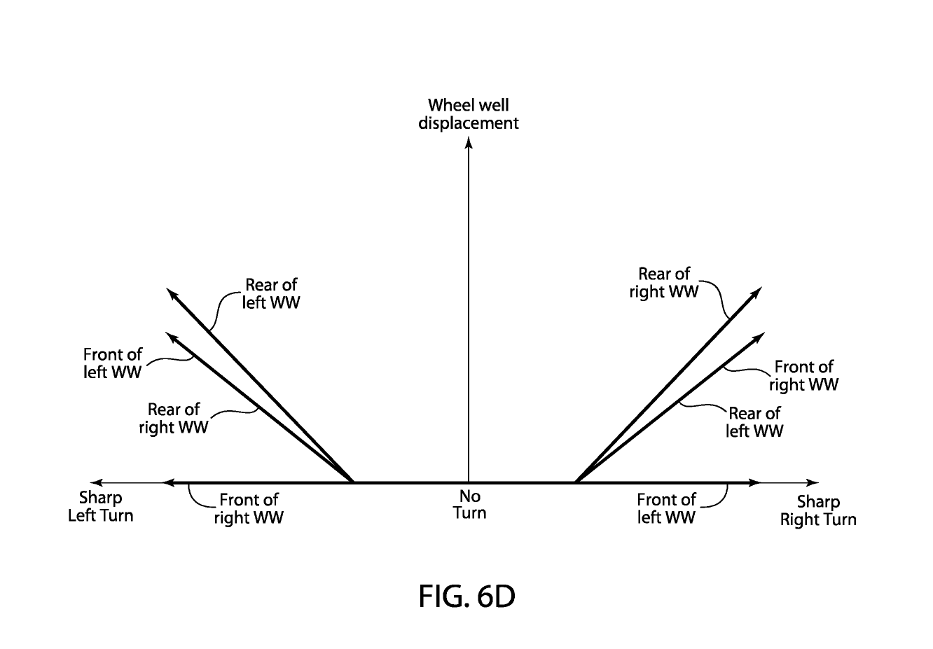

For a given turning angle, the position of the wheel well cover can depend, in some embodiments, upon the speed of the vehicle. In some instances, given a fixed turning angle, the wheel well cover can be constructed and arranged to assume a first position when the vehicle is moving at a first speed and a second position when the vehicle is moving at a second speed that is different from the first speed. FIG. 6A includes a schematic illustration of wheel well cover positions at high and low speeds for a left-hand turn at a fixed turning angle, according to some embodiments. In FIG. 6A, when the vehicle makes the left-hand turn at a relatively slow speed, the front of the front left wheel well cover (indicated as point 602) extends relatively far away from the vehicle while the rear of the front left wheel well cover (indicated as point 604) remains relatively close to the vehicle. In addition, during the left-hand turn (at the same fixed turning angle) at a relatively slow speed, the rear of the front right wheel well cover (indicated as point 606) can extend relatively far away from the vehicle while the front of the front right wheel well cover (indicated as point 608) can remain relatively close to the vehicle. The positions of the wheel well covers in this configuration is illustrated by the solid lines in FIG. 6A.

At higher speeds during the same left-hand turn, however, the position of the left wheel well cover may be adjusted, in some embodiments. For example, in FIG. 6A, at relatively high speeds, the rear of the front left wheel well cover may be moved relatively far away from the vehicle (indicated by point 610). The position of the wheel well cover in this arrangement is indicated by the dashed line in FIG. 6A. Such an adjustment might be made, for example, to increase the aerodynamic stability of the wheel well cover. In many cases, if the front of the wheel well cover is positioned farther out from the body of the vehicle than the rear of the wheel well cover at relatively high speeds, incoming air could exert a large, outward force on the wheel well cover, which could cause damage. At intermediate speeds at the same fixed turning angle, the rear portion of the front left wheel well cover could assume any of the positions along line 612.

FIG. 6B includes a schematic illustration of wheel well cover positions at high and low speeds for a right hand turn at a fixed turning angle, according to some embodiments. In FIG. 6B, when the vehicle makes a right turn at a relatively slow speed, the front of the front right wheel well cover (indicated as point 622) extends relatively far away from the vehicle while the rear of the front right wheel well cover (indicated as point 624) remains relatively close to the vehicle. In addition, during the same right-hand turn at a relatively slow speed, the rear of the front left wheel well cover (indicated as point 626) can extend relatively far away from the vehicle while the front of the front left wheel well cover (indicated as point 628) can remain relatively close to the vehicle. The positions of the wheel well covers in this configuration is illustrated by the solid lines in FIG. 6B. The position of the right wheel well cover during the same right-hand turn may be adjusted at higher speeds, in some embodiments. In FIG. 6B, at relatively high speeds (and the same turning angle), the rear of the front right wheel well cover may be moved relatively far away from the vehicle (indicated by point 630). The position of the wheel well cover in this arrangement is indicated by the dashed line in FIG. 6B. As before, such an adjustment might be made, for example, to increase the aerodynamic stability of the wheel well cover. At intermediate speeds at the same right-hand turning angle, the rear portion of the front right wheel well cover could assume any of the positions along line 632.

The positions of the wheel well covers could also depend upon the turning angle, with larger turning angles requiring the wheel well covers to be extended farther away from the vehicle. FIGS. 6C-6D include exemplary plots of the displacements of the front and rear portions of the front left and front right wheel well covers as a function of turning angle at relatively slow and relatively fast speeds, respectively.

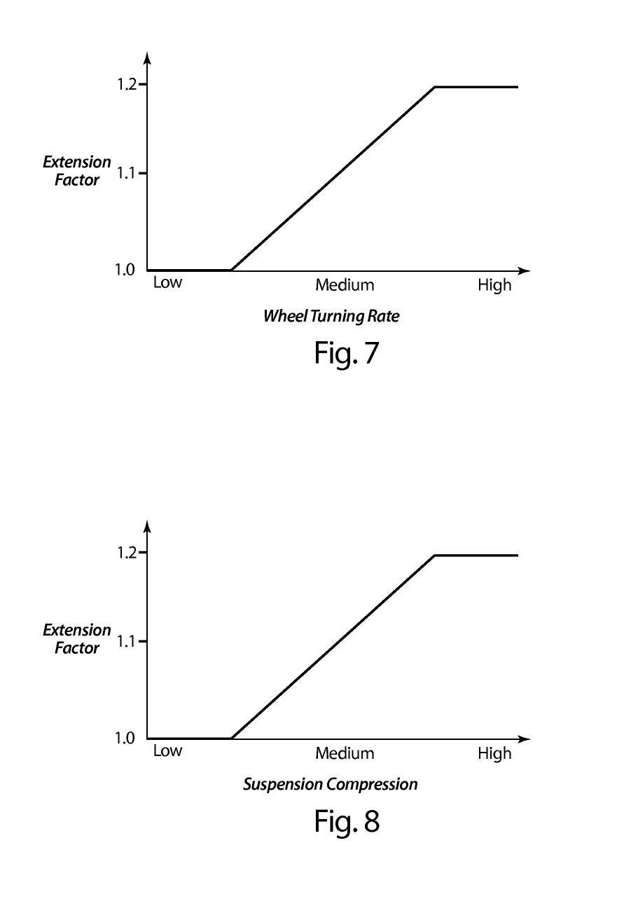

In some cases, the position of the wheel well cover can be controlled based upon the rate at which the steering angle of the wheels is varied. In some embodiments, when the wheels are turned relatively quickly, the wheel well covers can be displaced farther away from the side of the vehicle, relative to the position they would assume were the wheels turned relatively slowly. The increase in the displacement of the wheel well cover relative to the default displacement can be thought of in terms of an extension factor, which is defined as a multiple of the default wheel well cover displacement. For example, an extension factor of 1.2 corresponds to a wheel well cover displacement that is 1.2 times the default displacement observed for a given vehicle speed and turning angle. FIG. 7 includes an exemplary plot of the extension factor as a function of the wheel turning rate. At relatively low wheel turning rates, the wheel well cover displacement (i.e., the distance between the wheel well cover and the side of the vehicle at a given point on the wheel well cover) can be set to the default displacement (i.e., the extension factor can be set to 1.0). At relatively fast wheel turning rates, the displacement of the wheel well cover can be relatively large (e.g., at least about 20% larger than the default displacement, corresponding to an extension factor of 1.2).

The position of the wheel well covers can also be dependent, in some cases, upon the suspension compression. FIG. 8 includes an exemplary plot of the extension factor as a function of the suspension compression. In some embodiments, when the suspension is relatively uncompressed, the wheel well cover displacement can be set to the default displacement (i.e., the extension factor can be set to 1.0). When the vehicle suspension is relatively highly compressed (e.g., when the suspension is fully compressed), the displacement of the wheel well cover can be set to be relatively large (e.g., at least about 20% larger than the default displacement, corresponding to an extension factor of 1.2). Extra displacement at higher suspension compression can be useful in providing extra clearance for the wheel as it is turned. For example, in some cases the wheel well cover could be curved to help accommodate a portion of a turned wheel (e.g., the wheel well could be curved such that the part of the wheel that extends the farthest distance from the edge of the car upon turning is aligned with the apex of the curve). In some such cases, compression of the suspension could disturb the alignment of the wheel and the wheel well cover such that the wheel well cover would be required to move farther away from the side of the car to accommodate the angled wheel.

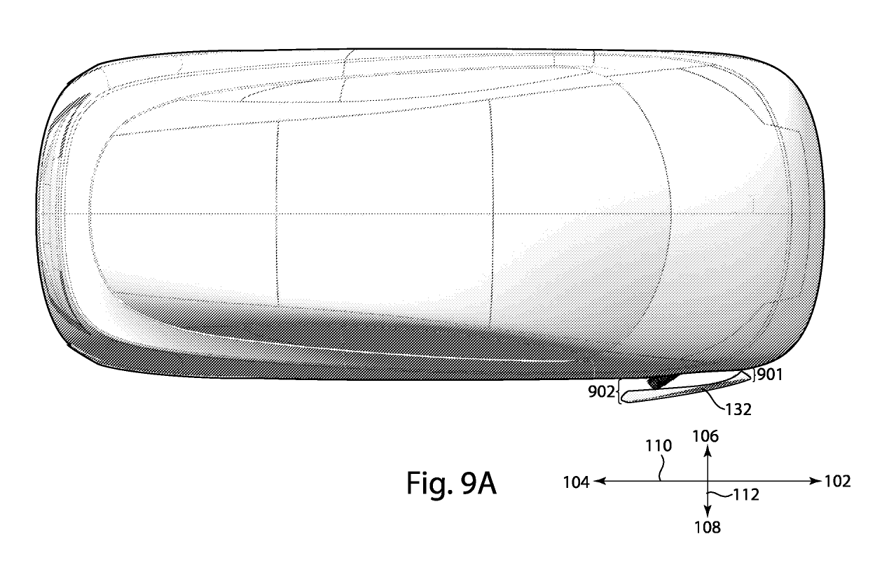

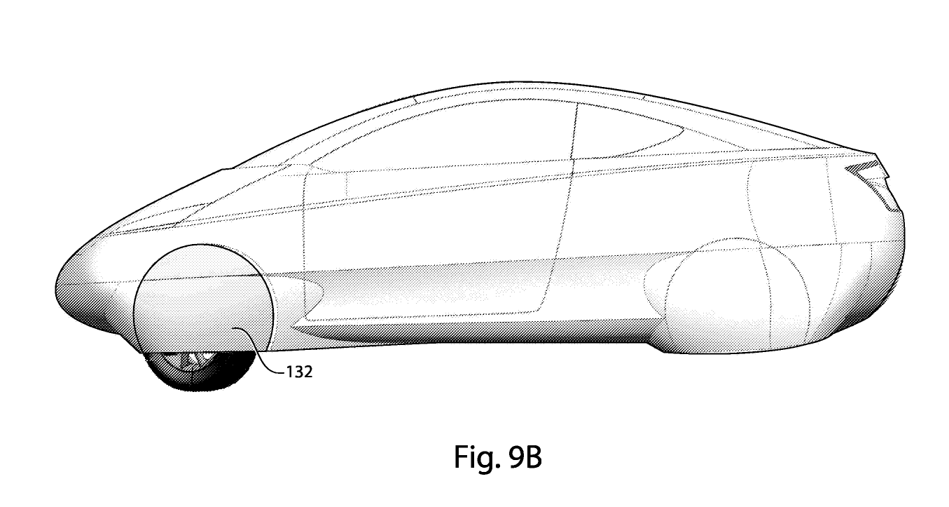

In some cases, the wheel well cover control system can be constructed and arranged such that the front and rear of the wheel well cover are retained at an outboard position under conditions in which the wheel is expected to turn at large angles. In some embodiments, the front and rear of the wheel well cover can be moved to an outward position by default when the vehicle is traveling at a speed lower than a predetermined speed (e.g., wherein the predetermined speed is somewhere between about 20 and about 40 miles per hour). For example, the wheel well cover can be moved to an outward position at relatively low speeds (e.g., less than about 40 mph, less than about 30 mph, less than about 20 mph), to allow for large tire angles (e.g., during slow and/or medium speed cornering and parking). FIG. 9A includes a schematic diagram of a wheel well cover in such a position. In FIG. 9A, front portion of wheel well cover 132 is spaced apart from the side of the vehicle a distance indicated by dimension 901. In addition, rear portion of wheel well cover 132 is spaced apart from the side of the vehicle a distance indicated by dimension 902.

In some cases, the wheel well cover control system can be constructed and arranged such that, above a predetermined speed (e.g., wherein the predetermined speed is somewhere between about 20 and about 40 miles per hour), the wheel well cover can be positioned such that it is flush with the side of the vehicle. For example, at relatively high speeds (e.g., at least about 20 mph, at least about 30 mph, at least about 40 mph) the wheel well cover actuation mechanism can be activated. Once the actuation mechanism is activated, the wheel well cover can retract toward the vehicle such that it is flush with the side of the vehicle during straight movement (e.g., as shown in FIG. 9B), and movable when the vehicle is steered (e.g., via any of the actuation mechanisms described herein or other suitable actuation arrangements).

The actuation system can also include, in some embodiments, an emergency setting that automatically extends the wheel well cover to its outward position. For example, the actuation wheel well cover actuation mechanism can be spring loaded such that the wheel well cover is extended (e.g., fully extended) if a tire is turned quickly and/or when an object is trapped between the wheel well cover and the vehicle body.

The position of the wheel well covers can be controlled using any suitable controller. In some cases, the processing functions of the wheel well position controller can be performed by at least one microprocessor, which in one embodiment is an onboard vehicle controller. In addition, the wheel well position controller can be programmed using any suitable programming language. In some cases, wheel well position control can be implemented using a standardized protocol. For example, in some embodiments, each of the wheel well cover actuators and/or controllers associated therewith can be connected to a controller area network (CAN).

U.S. Provisional Patent Application No. 61/365,213, filed Jul. 16, 2010, and entitled “Aerodynamic Performance in Passenger Vehicles” is incorporated herein by reference in its entirety for all purposes.

The following example is intended to illustrate certain embodiments of the present invention, but does not exemplify the full scope of the invention.

### EXAMPLE

This example describes a scheme to control the position of wheel well covers in response to the speed of a vehicle, turning direction, turning angle, turning rate, and suspension compression. Table 1 outlines the conditions of the 6 vehicle turning states described in this example. Table 2 includes a summary of the positions of the front and rear portions of the front left and front right wheel well covers in response to the conditions outlined in Table 1. In Table 2, 100% extension corresponds to a wheel well cover portion that is fully extended from the side of the vehicle, while 0% extension corresponds to a wheel well cover portion that is substantially flush with the side of the vehicle.

TABLE 1
Conditions of the vehicle turning states described in Example 1

| Example | Vehicle | Turning | Turning | Rate of | Suspension |
|---|---|---|---|---|---|
| State | Speed | Direction | Angle | Turning | Compression |
| 1 | Low | Left | Small | Low | Neutral |
| 2 | Low | Right | High | High | Neutral |
| 3 | Medium | Left | Small | Low | Neutral |
| 4 | Medium | Left | Medium | High | Compressed |
| 5 | High | Left | Small | Low | Neutral |
| 6 | High | Left | Medium | Low | Neutral |

TABLE 2
Positions of front left and front right wheel well covers in response to the
conditions outlined in Table 1

| Example | Left Front | Left Rear | Right Front | Right Rear |
|---|---|---|---|---|
| State | Extension | Extension | Extension | Extension |
| 1 | 10% | 0% | 0% | 10% |
| 2 | 0% | 90% | 100% | 10% |
| 3 | 10% | 5% | 0% | 5% |
| 4 | 60% | 65% | 10% | 60% |
| 5 | 10% | 20% | 0% | 10% |
| 6 | 30% | 40% | 10% | 30% |

Examples State 1 corresponds to a small-angle, left-hand turn at low speeds. In this case, the rate of turning is low. In this situation, the wheel well covers are not moved much. The front portion of the front left wheel well cover and the rear portion of the front right wheel well cover are extended 10%, while the rear portion of the front left wheel well cover and the front portion of the front right wheel well cover are extended 0%.

Example State 2 corresponds to a high-angle, right-hand turn at low speeds, as might be observed in a parking lot. In this case, the rear portion of the front right wheel well cover is partially opened (to an extension of 10%) to allow air to flow out of the front right wheel well. In addition, the front portion of the front right wheel well cover is opened to 100% extension to allow room for the front right wheel to turn. The front portion of the front left wheel well cover remains next to the side of the vehicle (extended 0%), while the rear portion of the front left wheel well cover is extended 90% to make room as the front left wheel is turned.

Example State 3 is similar to Example State 1 (a small-angle, left-hand turn), except the vehicle speed has been increased. In this state, the aerodynamics of the vehicle are improved by opening the rear portion of the left front wheel well cover to a 5% extension. The front portion of the front left wheel well cover is extended 10%, the rear portion of the front right wheel well cover is extended 5%, and the front portion of the front right wheel well cover is extended 0%.

Example State 4 corresponds to a situation in which a medium angle, left-hand turn is being made at medium speeds and with a high rate of turning. In addition, the suspension in this case is compressed. In this situation, the rear portions of the front left and front right wheel well covers are extended farther out than the front portions to ensure that the wheel well covers are aerodynamically stable. In many cases, if the front portions are extended farther out than the rear portions, the incoming air might produce a large, outward force of the wheel well covers and cause damage. In this specific case, the front portion of the front left wheel well cover is extended 60%, and the rear portion of the front left wheel well cover is extended 65%. In addition, the front portion of the front right wheel well cover is extended 10%, and the rear portion of the front right wheel well cover is extended 60%.

At high vehicle speeds, the rear portions of the wheel well covers can be configured to be farther out than the front portions, for the aerodynamic reasons outlined above. Example State 5 corresponds to a small-angle, left-hand turn made at high vehicle speeds. The turning rate is low, and the suspension compression is neutral. In this case, the front portion of the front left wheel well cover is extended only 10%, while the rear portion of the front left wheel well cover is extended 20%. In addition, the front portion of the front right wheel well cover is extended 0%, and the rear portion of the front right wheel well cover is extended 10%.

Examples State 6 is similar to Example State 5, except that the turning angle has been increased. In this case, each of the front wheel well covers are extended farther out to improve aerodynamic stability. In this case, the front portion of the front left wheel well cover is extended 30%, and the rear portion of the front left wheel well cover is extended 40%. In addition, the front portion of the front right wheel well cover is extended 10%, and the rear portion of the front right wheel well cover is extended 30%.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the embodiment(s) is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, the embodiments may be practiced otherwise than as specifically described and claimed. The embodiments are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the embodiments described herein.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A passenger vehicle comprising:
a wheel well; and
a moveable wheel well cover,
wherein, at a given turning angle, the wheel well cover is constructed and arranged to assume a position dependent upon at least one of the speed of the vehicle, the turning rate, and the suspension compression.

2. A passenger vehicle as in claim 1, wherein the wheel well cover is constructed and arranged to assume a position dependent upon the speed of the vehicle.

3. A passenger vehicle as in claim 1, wherein the wheel well cover is constructed and arranged to assume a position dependent upon the turning rate.

4. A passenger vehicle as in claim 1, wherein the wheel well cover is constructed and arranged to assume a position dependent upon the suspension compression.

5. A passenger vehicle as in claim 1, wherein:
the wheel well cover comprises a front portion and a rear portion,
at a first vehicle speed, the rear portion of the wheel well cover is separated from the side of the vehicle a smaller distance than the front portion of the wheel well cover, and
at a second vehicle speed faster than the first vehicle speed, the rear portion of the wheel well cover is separated from the side of the vehicle a larger distance than the front portion of the wheel well cover.

6. A passenger vehicle as in claim 1, wherein:
at a first turning rate, the wheel well cover is separated from the side of the vehicle a first distance, and
at a second turning rate larger than the first turning rate, the wheel well cover is separated from the side of the vehicle a second distance that is larger than the first distance.

7. A passenger vehicle as in claim 1, wherein:
at a first state in which the suspension is relatively uncompressed, the wheel well cover is separated from the side of the vehicle a first distance, and
at a second state in which the suspension is relatively compressed, the wheel well cover is separated from the side of the vehicle a second distance that is larger than the first distance.

8. A passenger vehicle comprising:
a longitudinal axis extending from a front end to a rear end of the vehicle;
a transverse axis extending from a first side to a second side of the vehicle;
a wheel well; and
an underbody surface comprising a recessed portion adjacent the wheel well, a line joining the wheel well and the recessed portion substantially parallel to the transverse axis of the vehicle,
wherein the recessed portion is constructed and arranged to mitigate or inhibit the development of high pressure zones underneath the vehicle while the vehicle is moving.

9. A passenger vehicle as in claim 8, wherein no two cross-sectional areas underneath the vehicle through which the air flows vary in area by more than about 20%.

10. A passenger vehicle as in claim 8, wherein no two control volumes that span the width of the vehicle and have substantially equal lengths vary in volume by more than about 20%.

11. A passenger vehicle as in claim 8, further comprising a wheel well cover substantially enclosing the wheel well.

12. A passenger vehicle as in claim 11, wherein the wheel well cover is constructed and arranged to move relative to a wheel within the wheel well.

13. A passenger vehicle as in claim 8, wherein the vehicle further comprises a wheel fairing adjacent the wheel well, the wheel fairing shaped to form an angle at its rearmost point.
